(19) United States
(12) Patent Application Publication
(10) Pub. No.: US 2025/0118472 A1
(43) Pub. Date: Apr. 10, 2025

(54) MAGNETIC CORE STRUCTURE

(71) Applicant: LITE-ON Technology Corporation, Taipei (TW)

(72) Inventors: Chen CHEN, Taipei (TW); Ching-Chia CHEN, Taipei (TW); Cheng-Wei TSENG, Taipei (TW); Yong-Long SYU, Taipei (TW); Kai-De CHEN, Taipei (TW)

(21) Appl. No.: 18/652,822

(22) Filed: May 2, 2024

Related U.S. Application Data
(60) Provisional application No. 63/588,303, filed on Oct. 6, 2023.

(30) Foreign Application Priority Data
Mar. 22, 2024 (TW) 113110885

(51) Int. Cl. H01F 3/00; H01F 27/28

(52) U.S. Cl. CPC H01F 3/00; H01F 27/2823

(57) ABSTRACT

A magnetic core structure is disclosed. The magnetic core structure includes a bottom plate, two magnetic columns, a sidewall and a cover plate. The two magnetic columns are disposed on the bottom plate. The sidewall has a first wall portion, a second wall portion and a third wall portion. The first wall portion and the second wall portion are disposed on two sides of the bottom plate along an axial direction of the two magnetic columns. The third wall portion is disposed between the two magnetic columns, and the third wall portion is connected to the first wall portion and the second wall portion, respectively. The cover plate is disposed on the sidewall and covers the two magnetic columns. Another magnetic core structure is also provided.

### CROSS-REFERENCE TO RELATED APPLICATIONS

This application claims the priority benefits of U.S. Patent Application No. 63/588,303, filed on Oct. 6, 2023 and TW patent application No. 113110885, filed on Mar. 22, 2024, the full disclosure of which is incorporated herein by reference.

### TECHNICAL FIELD OF THE INVENTION

This application is related to a technical field of magnetic core, and particularly is related to a magnetic core structure.

### DESCRIPTION OF THE RELATED ART

In the current market, the magnetic core is a magnetic material with high magnetic permeability, which can restrict and guide the magnetic field in an electromechanical magnetic equipment or a magnetic equipment. The magnetic core may be made by ferromagnetic metals or ferrimagnetic compounds. Although the magnetic core can increase the magnetic field strength of the electromagnetic coil, the magnetic core also has the disadvantage of causing energy loss (core damaged). Furthermore, the magnetic core and the coil will generate heat during the interaction. The poor heat dissipation of the magnetic core causes the magnetic core damaged severely.

### SUMMARY OF THE INVENTION

The embodiments of the present application provide a magnetic core structure to solve the severe issue of magnetic core damaged in the magnetic core structure by designing the structure of the magnetic core.

To solve the aforementioned issue, the present application is embodied as follows.

The first aspect provides a magnetic core structure, including a bottom plate, two magnetic columns, a sidewall and a cover plate. The two magnetic columns are disposed on the bottom plate. The sidewall has a first wall portion, a second wall portion and a third wall portion. The first wall portion and the second wall portion are disposed on two sides of the bottom plate along an axial direction of the two magnetic columns. The third wall portion is disposed between the two magnetic columns, and the third wall portion is connected to the first wall portion and the second wall portion, respectively. The cover plate is disposed on the sidewall and covers the two magnetic columns.

In one embodiment, the bottom plate has a first long side, a second long side, a first short side and a second short side, the first long side and the second long side are opposite to each other, the first short side and the second short side are disposed between the first long side and the second long side, the first side potion is disposed on the first long side, and the second wall portion is disposed on the second long side.

In one embodiment, two ends of the first wall portion extend along the first long side, and two ends of the first wall portion extend and turn to the first short side and the second short side, respectively, and two ends of the second wall portion extend along the second long side, respectively.

In one embodiment, the turned extension length of the two ends of the first wall portion is located within a range of a vertical projection of the adjacent magnetic columns to the first short side and the second short side.

In one embodiment, the extension length of the two ends of the second wall portion is located within a range of vertical projections of the two magnetic columns onto the second long side.

In one embodiment, two first openings are located at corners constituted by the second long side and the first short side and constituted by the second long side and the second short side, respectively.

In one embodiment, two first openings are located at corners constituted by the second long side and the first short side and constituted by the second long side and the second short side, respectively.

In one embodiment, the two ends of the first wall portion extend over a range of vertical projections of the two magnetic columns onto the first long side, and the two ends of the second wall portion extend over a range of vertical projections of the two magnetic columns onto the second long side, respectively.

In one embodiment, an extension length of the two ends of the first wall portion is the same as that of the two ends of the second wall portion.

In one embodiment, two second openings are disposed between the two ends of the first wall portion and the two ends of the second wall portion, and the two second openings are located at the first short side and the second short side, respectively.

In one embodiment, the first wall portion has two through holes corresponding to the two magnetic columns.

In one embodiment, the sidewall adjacent to cylindrical surfaces of the two magnetic columns has a corresponding curved wall surface, and a gap is located between the curved wall surface of the sidewall and cylindrical surfaces of the two magnetic columns.

In one embodiment, two coils are further included. The two coils winds with the two magnetic columns, and the two coils are disposed within the gap.

The second aspect provides a magnetic core structure, including a bottom plate, two magnetic columns, a sidewall and a cover plate. The two magnetic columns are disposed on the bottom plate. The sidewall has a first wall portion and a second wall portion. The first wall portion is disposed on a side of the bottom plate along an axial direction of the two magnetic columns, the first wall portion extends and turns to adjacent sides of the bottom plate, and one end of the second wall portion extends from the first wall portion by passing a space between the two magnetic columns. The cover plate is disposed on the sidewall and covers the two magnetic columns.

In one embodiment, the bottom plate has a first long side, a second long side, a first short side and a second short side, the first long side and the second long side are opposite to each other, the first short side and the second short side are disposed between the first long side and the second long side, and the first wall portion is disposed on the first long side, the first short side and the second short side.

In one embodiment, a third opening is disposed between two ends of the first wall portion and the third opening is disposed on the second long side.

In one embodiment, the first wall portion on the first long side has two through holes corresponding to the two magnetic columns, respectively.

In one embodiment, the first wall portion and the second wall portion adjacent to cylindrical surfaces of the two magnetic columns have corresponding curved wall surfaces, and a gap is located among the curved wall surfaces of the first wall portion and the second wall portion and the cylindrical surfaces of the two magnetic columns.

In one embodiment, two coils are further included. The two coils winds with the two magnetic columns, and the two coils are disposed within the gap.

The present application provides a magnetic core structure through the design of the sidewall structure relative to the two magnetic columns. The two coils are wound around the two magnetic columns, and current flows through the two coils to generate a magnetic field. The sidewall can improve the magnetic field of the coil and effectively reduce the overall damages caused by the core structure to the coil. Furthermore, the design of the sidewall in the magnetic core structure is beneficial for air convection to perform heat dissipation for the magnetic columns and the coils.

It should be understood, however, that this summary may not contain all aspects and embodiments of the present invention, that this summary is not meant to be limiting or restrictive in any manner, and that the invention as disclosed herein will be understood by one of ordinary skill in the art to encompass obvious improvements and modifications thereto.

### BRIEF DESCRIPTION OF DRAWINGS

The accompanying drawings herein is provided to have a further understanding on the present application and constitutes a part of the present application. The schematic embodiments and the description of the present application is used to explain the present application instead of constituting inappropriate limitation. In the drawings:

FIG. 1 is a perspective view of the magnetic core structure according to the first embodiment of the present application;

FIG. 2 is a cross-sectional view along line A-A′ in FIG. 1;

FIG. 3 is an exploded view of the magnetic core structure according to the first embodiment of the present application;

FIG. 4 is a perspective view of the magnetic core structure according to the second embodiment of the present application;

FIG. 5 is a cross-sectional view of line B1-B1′ in FIG. 4;

FIG. 6 is a cross-sectional view of line B2-B2′ in FIG. 4;

FIG. 7 is an exploded view of the magnetic core structure according to the third embodiment of the present application;

FIG. 8 is an exploded view of the magnetic core structure according to the fourth embodiment of the present application;

FIG. 9 is a perspective view of the magnetic core structure according to the fifth embodiment of the present application;

FIG. 10 is a cross-sectional view along line C-C′ of FIG. 9;

FIG. 11 is an exploded view of the magnetic core structure according to the fifth embodiment of the present application;

FIG. 12 is a perspective view of a magnetic core structure according to the sixth embodiment of the present application;

FIG. 13 is a cross-sectional view along line D-D′ of FIG. 12;

FIG. 14 is an exploded view of the magnetic core structure according to the seventh embodiment of the present application;

FIG. 15 is an exploded view of the magnetic core structure according to the eighth embodiment of the present application;

FIG. 16 is a perspective view of the magnetic core structure according to the ninth embodiment of the present application;

FIG. 17 is a cross-sectional view along line E-E′ of FIG. 16;

FIG. 18 is an exploded view of the magnetic core structure according to the ninth embodiment of the present application;

FIG. 19 is a perspective view of a magnetic core structure according to the tenth embodiment of the present application;

FIG. 20 is a cross-sectional view along line F-F′ of FIG. 19;

FIG. 21 is an exploded view of the magnetic core structure according to the eleventh embodiment of the present application; and

FIG. 22 is an exploded view of a magnetic core structure according to the twelfth embodiment of the present application.

### DETAILED DESCRIPTION OF THE INVENTION

The multiple embodiments of the present application are disclosed by the drawings as follows, and for precise explanation, the implementing details of the present application will be described together with the multiple embodiments of the present application in the following paragraphs. However, it should be understood that the implementing details of the present application should not be construed as the restrictions of the present application. In other words, in some of the embodiments of the present application, the implement details of the present application are not essential. Besides, for simplifying the drawings, some well-known structures and modules are schematically shown to simplify the drawings. In the following embodiments, the same reference numerals in different drawings represent the same or similar modules.

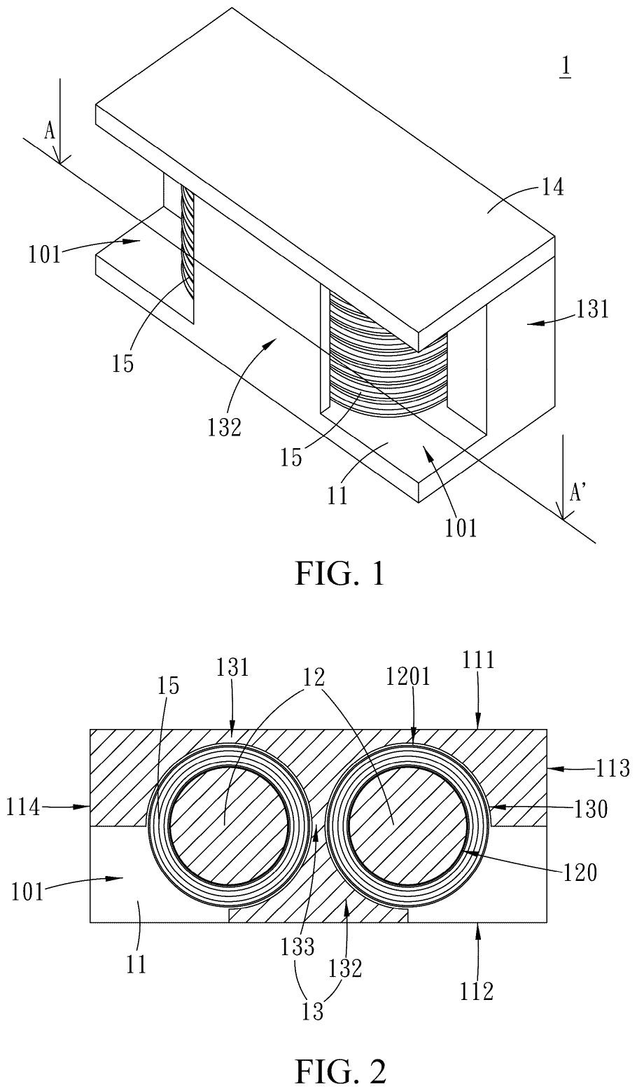

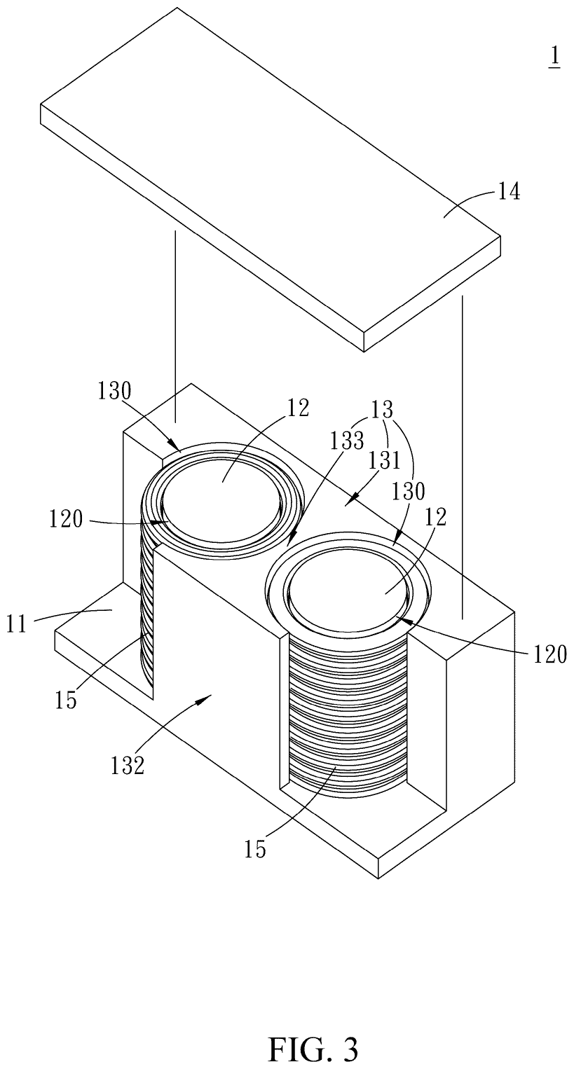

Please refer to FIG. 1 to FIG. 3 where FIG. 1 is a perspective view of the magnetic core structure according to the first embodiment of the present application, FIG. 2 is a cross-sectional view along line A-A′ in FIG. 1, and FIG. 3 is an exploded view of the magnetic core structure. As shown in the figures, the present application provides a magnetic core structure 1 which includes a bottom plate 11, two magnetic columns 12, a sidewall 13 and a cover plate 14. The two magnetic columns 12 are disposed on the bottom plate 11. The sidewall 13 includes a first wall portion 131, a second wall portion 132 and a third wall portion 133. The first wall portion 131 and the second wall portion 132 are disposed on two sides of the bottom plate 11 along an axial direction of the two magnetic columns 12, the third wall portion 133 is disposed between the two magnetic columns 12, and the third wall portion 133 is connected to the first wall portion 131 and the second wall portion 132, respectively. The cover plate 14 is disposed on the sidewall 13 and covers the two magnetic columns 12. The bottom plate 11, magnetic column 12 and the sidewall 13 may be formed integrally, and the sizes of the bottom plate 11 and the cover plate 14 are the same.

In this embodiment, the bottom plate 11 has a first long side 111, a second long side 112, a first short side 113 and a second short side 114. The first long side 111 and the second long side 112 are opposite to each other. The first short side 113 and the second short side 114 are disposed between the first long side 111 and the second long side 112. The bottom plate 11 is a rectangular plate. The first wall portion 131 is disposed on the first long side 111, and the second wall portion 132 is disposed on the second long side 112. Two ends of the first wall portion 131 extend along the first long side 111 and two ends of the first wall portion extend and turn to the first short side 113 and the second short side 114, respectively, and two ends of the second wall portion 132 extend along the second long side 112, respectively. Two ends of the third wall portion 133 extend and connect toward the first wall portion 131 and the second wall portion 132 between the two magnetic columns 12. The first wall portion 131, second wall portion 132 and third wall portion 133 are formed integrally.

Furthermore, the turned extension length of the two ends of the first wall portion 131 is located within a range of a vertical projection of the adjacent magnetic columns 12 to the first short side 113 and the second short side 114. From the structure of the magnetic core structure 1 in the present embodiment, the two ends of the first wall portion 131 to the two ends of the second wall portion 132 respectively have two first openings 101. The two first openings 101 are located at corners constituted by the second long side 112 and the first short side 113 and constituted by the second long side 112 and the second short side 114, respectively. The first openings 101 expose the corresponding positions of the two magnetic columns 12 to the outside.

In this embodiment, the sidewall 13 adjacent to the cylindrical surfaces 120 of the two magnetic columns 12 has a corresponding curved wall surface 130, and the curved wall surface 130 of the sidewall 13 are configured to correspond to the profile of the cylindrical surfaces 120 of the magnetic columns 12. In other words, the curved wall surface 130 of the sidewall 13 and cylindrical surfaces 120 of the two magnetic columns 12 have a gap 1201 therebetween. In addition, the magnetic core structure 1 further includes two coils 15 wind with the two magnetic columns 12 and disposed in the gap 1201.

In this embodiment, the coil 15 have two winding manners for the magnetic column 12. When the coils 15 wind the magnetic columns 12 in the same direction, the directions of the currents flowing through the coils 15 are the same. A magnetic field will be generated when the current flows through the coils 15, and the magnetic field generates magnetic flux relative to the bottom plate 11, magnetic column 12, sidewall 13 and cover plate 14. The directions of the magnetic flux generated by the two coils 15 on the bottom plate 11 or the cover plate 14 will be opposite, thereby producing a magnetic flux offset effect, so that the iron damaged on the bottom plate 11 or the cover plate 14 will reduce. Further, the directions of the magnetic flux generated by the two coils 15 on the sidewall 13 are the same, thereby producing a magnetic flux superposition effect, so that the iron damaged on the sidewall 13 will increase.

When the coils 15 wind the magnetic columns 12 in the opposite directions, the directions of the currents flowing through the coils 15 are opposite. A magnetic field will be generated when the current flows through the coils 15, and the magnetic field generates magnetic flux relative to the bottom plate 11, magnetic column 12, sidewall 13 and cover plate 14. The directions of the magnetic flux generated by the two coils 15 on the bottom plate 11 or the cover plate 14 will be the same, thereby producing a magnetic flux superposition effect, so that the iron losses on the bottom plate 11 or cover plate 14 will increase. Further, the directions of the magnetic flux generated by the two coils 15 on the sidewall 13 are opposite, thereby producing a magnetic flux offset effect, so that the iron damaged on the sidewall 13 will reduce.

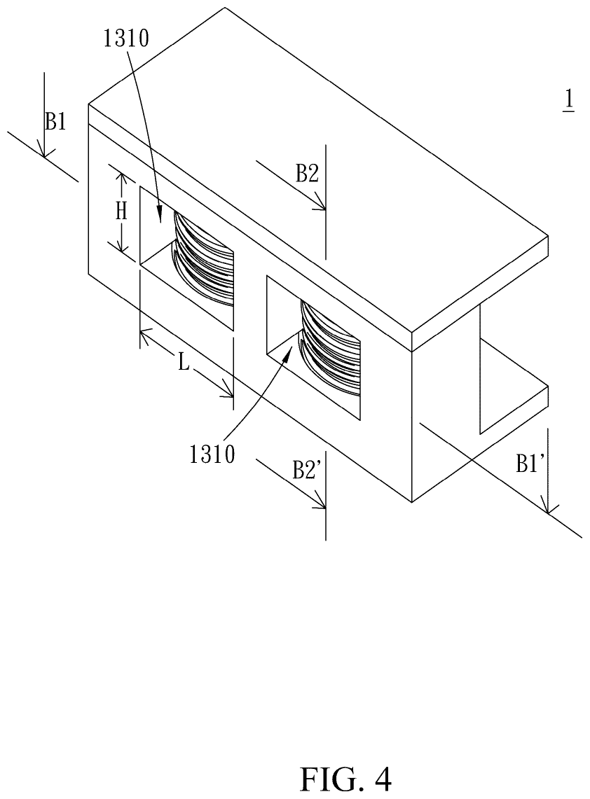

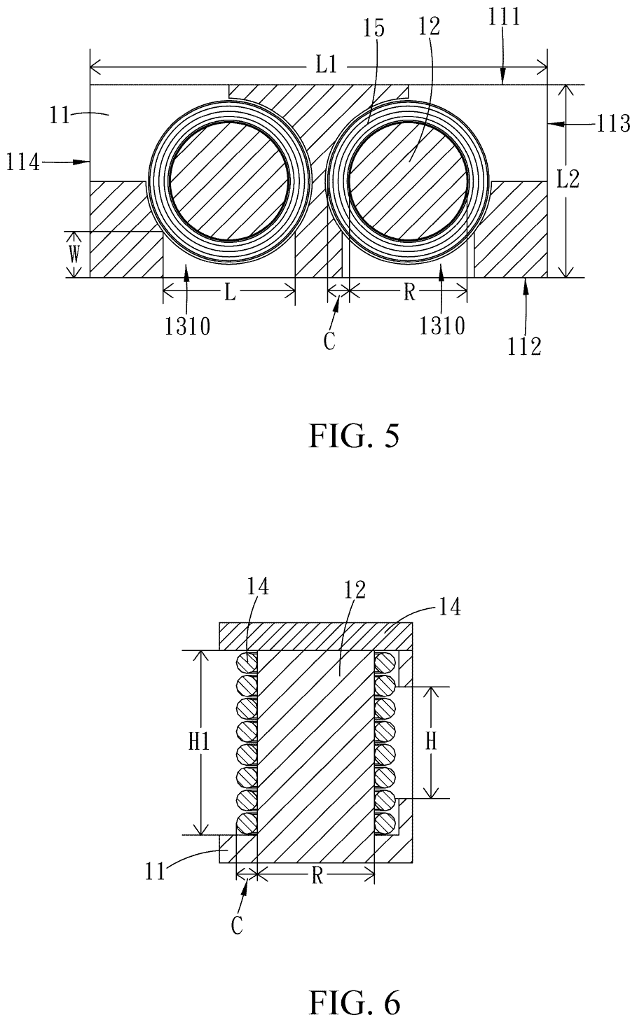

Please refer to FIG. 4 to FIG. 6 together where FIG. 4 is a perspective view of the magnetic core structure according to the second embodiment of the present application, FIG. 5 is a cross-sectional view of line B1-B1′ in FIG. 4, and FIG. 6 is a cross-sectional view of line B2-B2′ in FIG. 4. As shown in the figures, the difference between the present embodiment and the first embodiment lies in a through hole 1310. In this embodiment, the first wall portion 131 of the sidewall 13 further includes two through holes 1310 corresponding to the magnetic columns 12 and the coils 15 winds with the magnetic columns 12. In this embodiment, the structure of the sidewall 13 is altered through the through hole 1310 to change the magnetic field influence of the sidewall 13 on the coils 15. This changes the environment of the magnetic field that the magnetic field of the coils 15 is cut by the magnetic flux to further effectively reduce the condition of the copper wire damaged in the coils 15. In addition, the magnetic core structure 1 having the through hole 1310 may enhance the air convection through the structure of the magnetic columns 12 and the coils 15 to raise the heat dispassion effect for the magnetic columns 12 and the coils 15 of the magnetic core structure 1.

In this embodiment, each through hole 1310 has a length of the through hole L, a width of the through hole W, and a height of the through hole H, wherein L, W and H compared to the structure size of the magnetic core structure 1 have a specific relationship. The value range of L, W and H can be adjusted according to the requirement of the user, and the illustration in the table is as following.

Length of the through hole L (mm)

| | |
|---|---|
| Minimum | 1% of the length of the long side L1 of the |
| length | bottom plate 11 |
| Maximum | 95% of the length of the long side L1 of |
| length | the bottom plate 11 |

Width of the through hole W (mm)

| | |
|---|---|
| Minimum | [the length of the short side L2 of the |
| width | bottom plate 11 − ( the diameter of the |
| | magnetic column R + (the width of the |
| | wire C in the coil) * 2)] * 50% |
| Maximum | 50% of the length of the short side L2 of |
| width | the bottom plate 11 |

Height of the through hole H (mm)

| | |
|---|---|
| Minimum | 1% of the height H1 of the magnetic |
| height | column 12 |
| Maximum | 99% of the height H1 of the magnetic |
| height | column 12 |

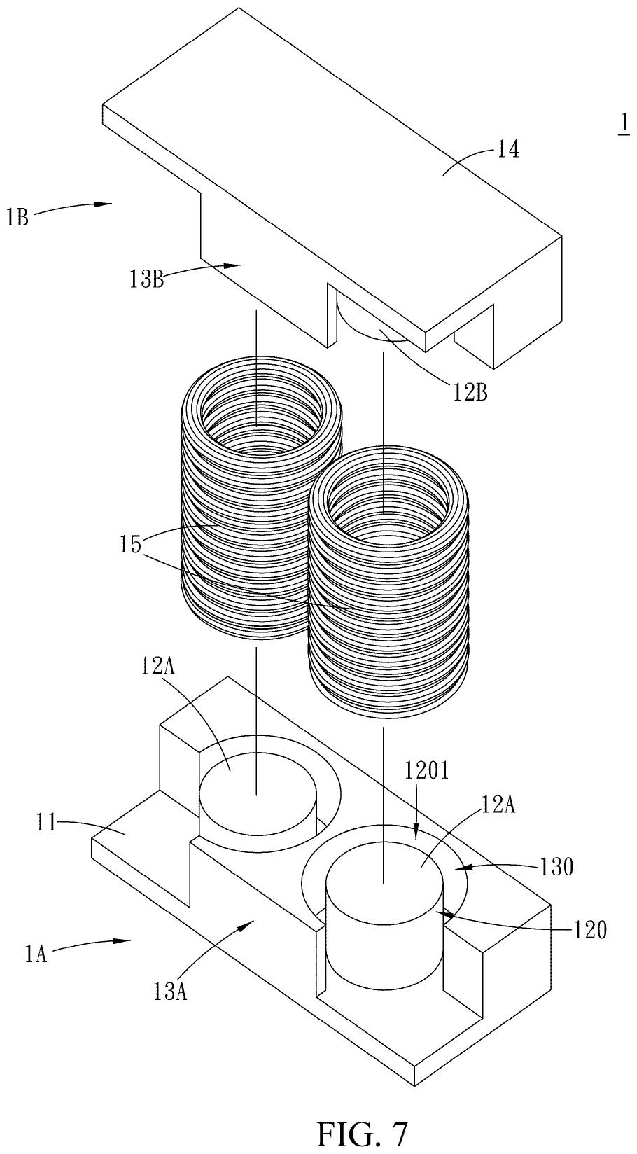

Please refer to FIG. 7, which is an exploded view of the magnetic core structure according to the third embodiment of the present application. As shown in the figure, the difference between the present embodiment and the first embodiment lies in the assemble manner of the structure. In the magnetic core structure 1 of this embodiment, each magnetic column 12 includes a lower magnetic column 12A and an upper magnetic column 12B corresponding to the lower magnetic column 12A, and the upper magnetic column 12B is stacked on the lower magnetic column 12A to form a complete magnetic column 12. Besides, the sidewall 13 of the magnetic core structure 1 includes a lower sidewall 13A and an upper sidewall 13B corresponding to the lower sidewall 13A, the upper sidewall 13B is stacked on the lower sidewall 13A to form a complete sidewall 13.

In this embodiment, the magnetic core structure 1 includes the bottom plate 11, two lower magnetic columns 12A, two upper magnetic columns 12B, the lower sidewall 13A, the upper sidewall 13B and the cover plate 14. The two lower magnetic columns 12A are disposed on the bottom plate 11, the lower sidewall 13A is disposed on the bottom plate 11, and the lower sidewall 13A is disposed around the peripheral sides of the two lower magnetic columns 12A. The bottom plate 11, two lower magnetic columns 12A and the lower sidewall 13A are integrally formed to a first magnetic core 1A. The two upper magnetic columns 12B are disposed on the cover plate 14, the upper sidewall 13B is disposed on the cover plate 14, and the upper sidewall 13B is disposed around the peripheral sides of the two upper magnetic columns 12B. The cover plate 14, two upper magnetic columns 12B and the upper sidewall 13B are integrally formed to a second magnetic core 1B. The first magnetic core 1A and the second magnetic core 1B have the same structure.

As mentioned above, the first magnetic core 1A is provided first, one end of each of the coil 15 of the magnetic core structure 1 winds with the two lower magnetic columns 12A of the first magnetic core 1A, then the two upper magnetic columns 12B and the upper sidewall 13B of the second magnetic core 1B are correspondingly stacked on the two lower magnetic columns 12A and the lower sidewall 13A of the first magnetic core 1A, at the same time, the other end of each of the coil 15 also winds with the two upper magnetic columns 12B of the second magnetic core 1B, so as to assemble the complete magnetic core structure 1. Furthermore, the coils 15 can also fix the stacked assembly of the first magnetic core 1A and the second magnetic core 1B.

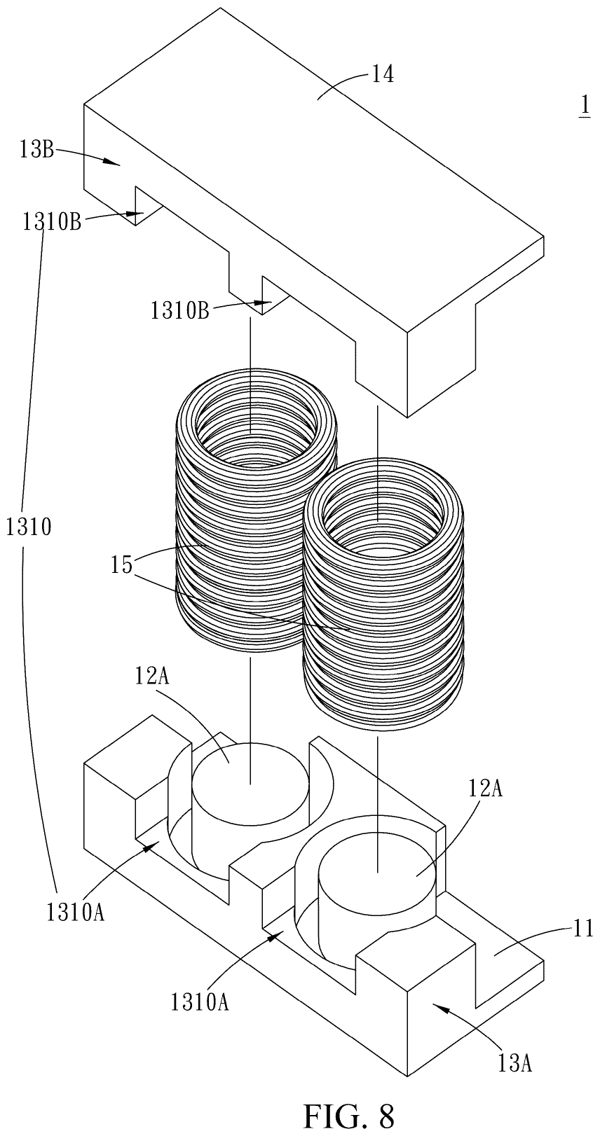

Please refer to FIG. 8, which is an exploded view of the magnetic core structure according to the fourth embodiment of the present application. As shown in the figure, the difference between the present embodiment and the third embodiment lies in the through hole 1310. In this embodiment, the first wall portion 131A of the lower sidewall 13A has a lower notch 1310A; the first wall portion 131B of the upper sidewall 13B has an upper notch 1310B, the lower notch 1310A corresponds to the upper notch 1310B with each other, and the through hole 1310 is composed of the lower notch 1310A and the upper notch 1310B. The effect of the through hole 1310 in this embodiment is the same as that in the second embodiment. Therefore, no further elaboration is necessary.

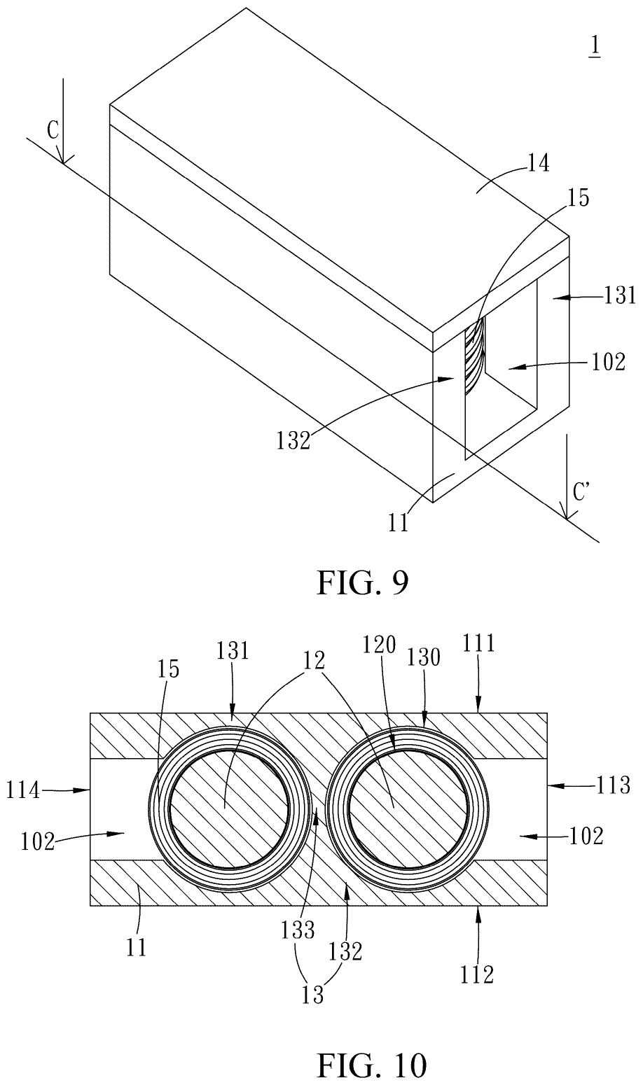

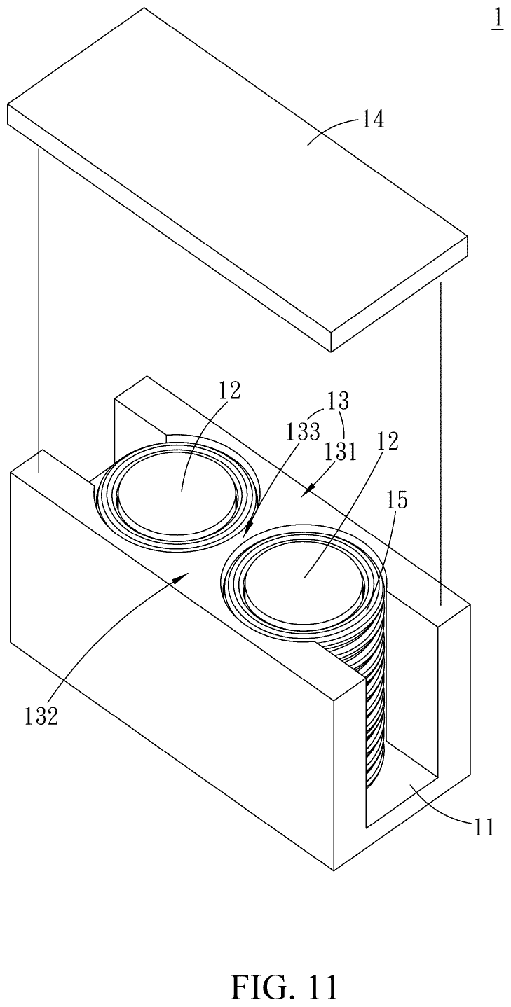

Please refer to FIG. 9 to FIG. 11 where FIG. 9 is a perspective view of the magnetic core structure according to the fifth embodiment of the present application, FIG. 10 is a cross-sectional view along line C-C′ of FIG. 9, and FIG. 11 is an exploded view of the magnetic core structure. As shown in the figures, the difference between the present embodiment and the first embodiment lies in the structure of the sidewall 13. The two ends of the first wall portion 131 respectively extend over the range that the magnetic columns 12 project vertically onto the second long side 112. The length extended by the two ends of the first wall portion 131 is the same as that extended by the two ends of the second wall portion 132. In other words, there are two second openings 102 disposed between the two ends of the first wall portion 131 and the two ends of the second wall portion 132, respectively. Two second openings 102 are disposed on the first short side 113 and the second short side 114, respectively, and the two second openings 102 expose the corresponding locations of the two magnetic columns 12 to the outside.

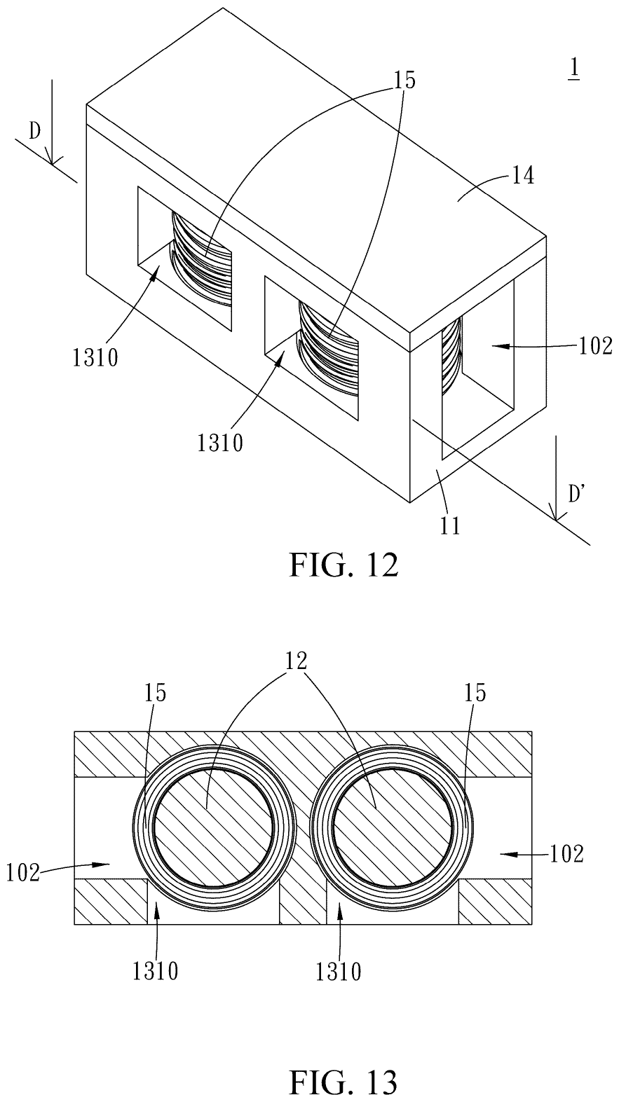

Please refer to FIG. 12 and FIG. 13 where FIG. 12 is a perspective view of a magnetic core structure according to the sixth embodiment of the present application, and FIG. 13 is a cross-sectional view along line D-D′ of FIG. 12. As shown in the figures, the difference between the present embodiment and the fifth embodiment lies in the through hole 1310. The first wall portion 131 has two through holes 1310, and the two through holes 1310 correspond to the two magnetic columns 12 and the coils 15 winding around the two magnetic columns 12. The effect of the through hole 1310 in this embodiment is the same as that in the second embodiment. Therefore, no further elaboration is necessary.

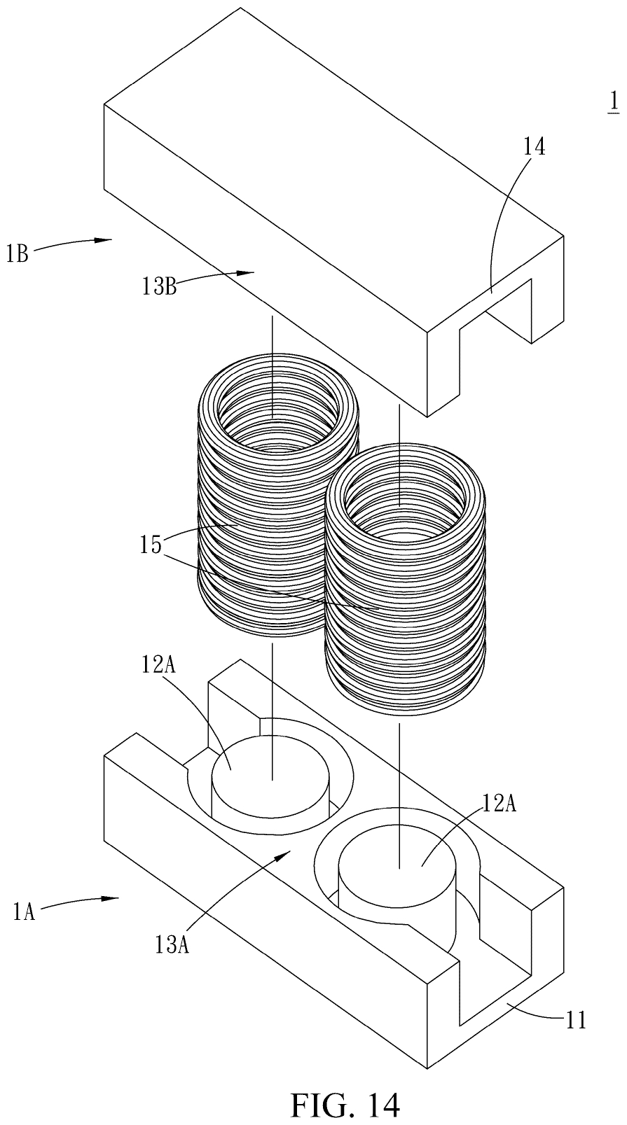

Please refer to FIG. 14, which is an exploded view of the magnetic core structure according to the seventh embodiment of the present application. As shown in the figure, the difference between the present embodiment and the fifth embodiment lies in the assemble manner of the structure. In the magnetic core structure 1 of this embodiment, each of the magnetic column 12 includes a lower magnetic column 12A and an upper magnetic column (not shown) corresponding to the lower magnetic column 12A, and the upper magnetic column is stacked on the lower magnetic column 12A to form a complete magnetic column 12. In addition, the sidewall 13 of the magnetic core structure 1 includes a lower sidewall 13A and a upper sidewall 13B corresponding to the lower sidewall 13A, and the upper sidewall 13B is stacked on the lower sidewall 13A to form a complete sidewall 13. The bottom plate 11, two lower magnetic columns 12A and the lower sidewall 13A are integrally formed to form the first magnetic core 1A. The cover plate 14, two upper magnetic columns and the upper sidewall 13B are integrally formed to form the second magnetic core 1B. The first magnetic core 1A and the second magnetic core 1B have the same structure. Then, the first magnetic core 1A, the second magnetic core 1B and the coils 15 are assembled. The effect in this embodiment is the same as that in the third embodiment. Therefore, no further elaboration is necessary.

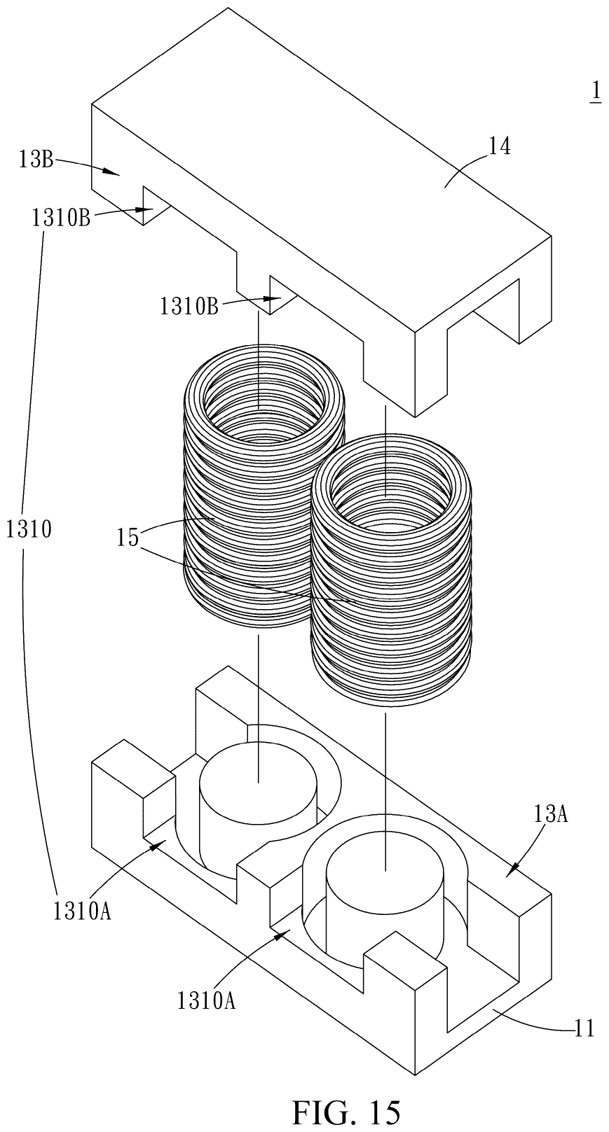

Please refer to FIG. 15, which is an exploded view of the magnetic core structure according to the eighth embodiment of the present application. As shown in the figure, the difference between the present embodiment and the third embodiment lies in the through hole 1310. In this embodiment, the first wall portion 131A of the lower sidewall 13A has a lower notch 1310A, and the first wall portion 131B of the upper sidewall 13B has a upper notch 1310B. The lower notch 1310A corresponds to the upper notch 1310B with each other, and the through hole 1310 is composed of the lower notch 1310A and the upper notch 1310B. The effect of the through hole 1310 in this embodiment is the same as that in the second embodiment. Therefore, no further elaboration is necessary.

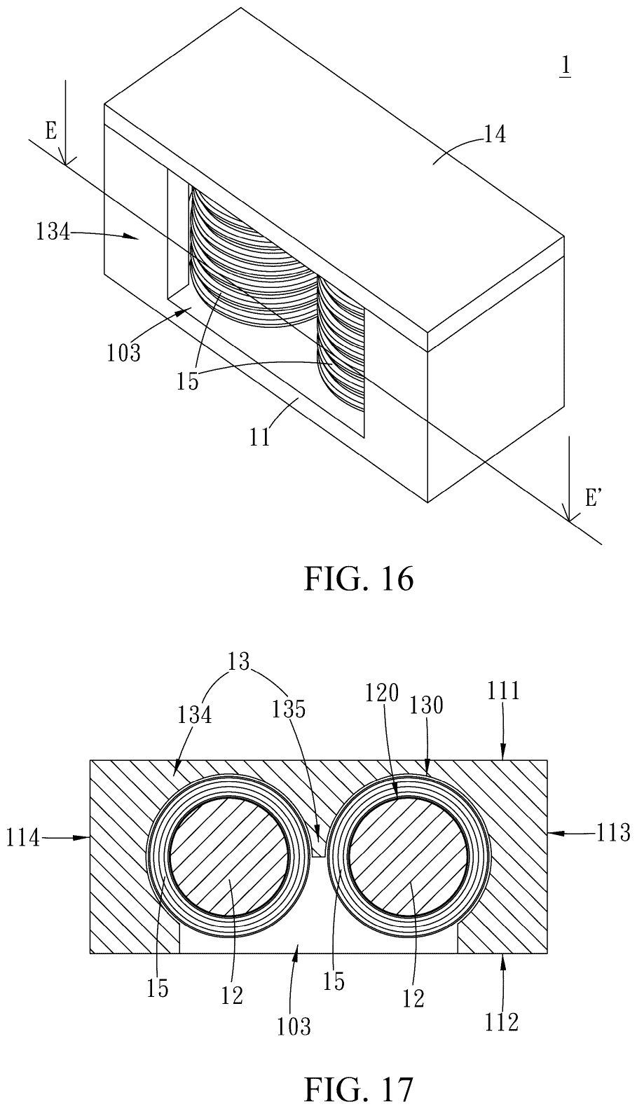

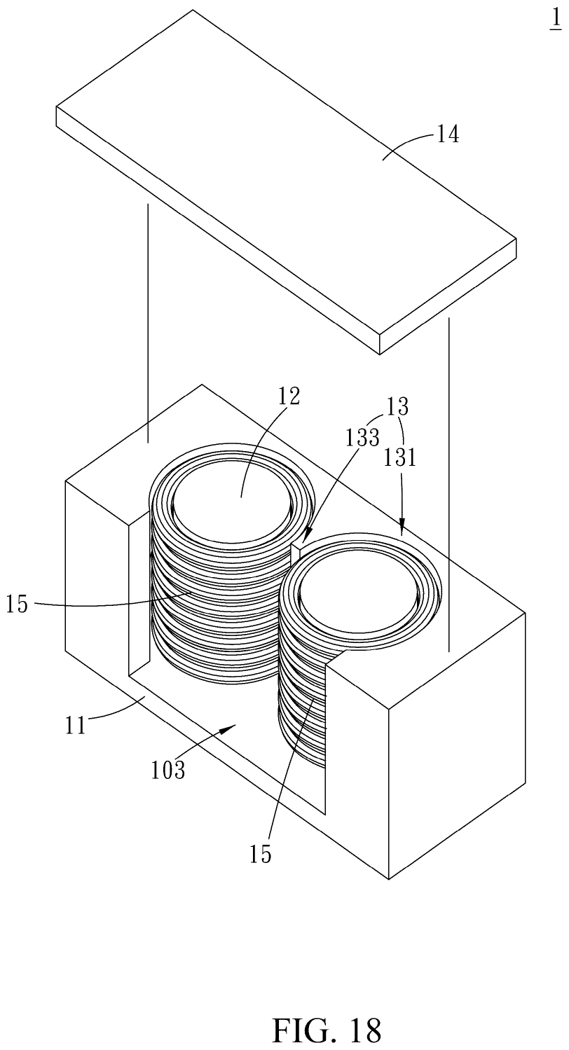

Please refer to FIG. 16 to FIG. 18 where FIG. 16 is a perspective view of the magnetic core structure according to the ninth embodiment of the present application, FIG. 17 is a cross-sectional view along line E-E′ of FIG. 16, and FIG. 18 is an exploded view of the magnetic core structure. As shown in the figures, the present application provides a magnetic core structure 1, including: a bottom plate 11, two magnetic columns 12, a sidewall 13 and a cover plate 14. The two magnetic columns 12 are disposed on the bottom plate 11. The sidewall 13 includes a first wall portion 134 and a second wall portion 135, the first wall portion 134 is positioned along sides of the bottom plate 11 in a direction of arrangement of the two magnetic columns 12, the first wall portion 134 extends and turns to adjacent sides of the bottom plate 11 along the outside of the two magnetic columns 12, and one end of the second wall portion 135 extends from the first wall portion 134 by passing a space between the two magnetic columns 12. The cover plate 14 is disposed on the sidewall 13 and covers the two magnetic columns 12.

In this embodiment, the bottom plate 11 has a first long side 111, a second long side 112, a first short side 113 and a second short side 114. The first long side 111 and the second long side 112 correspond to each other. The first short side 113 and the second short side 114 are disposed between the first long side 111 and the second long side 112. The first wall portion 134 is disposed on the first long side 111, the first short side 113 and the second short side 114. In other words, two ends of the first wall portion 134 have a third opening 103 therebetween, the third opening 103 is disposed on the second long side, and the third opening 103 exposes the corresponding positions of the two magnetic columns 12 to the outside simultaneously.

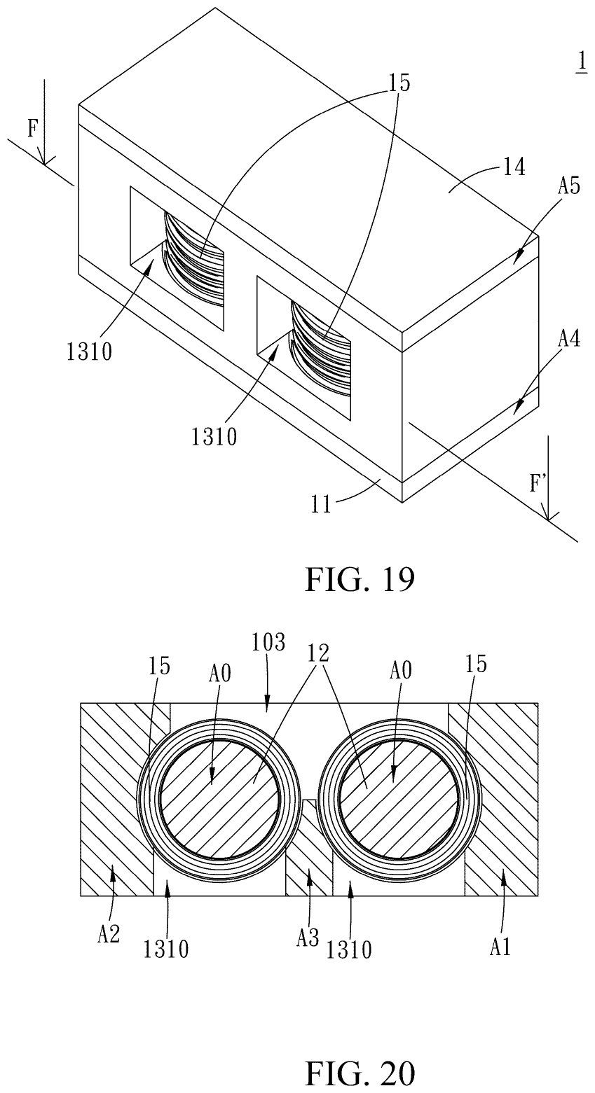

Please refer to FIG. 19 and FIG. 20 where FIG. 19 is a perspective view of a magnetic core structure according to the tenth embodiment of the present application, and FIG. 20 is a cross-sectional view along line F-F′ of FIG. 19. As shown in the figures, the difference between the present embodiment and the ninth embodiment lies in the through hole 1310. In this embodiment, the first wall portion 134 has two through holes 1310 which are disposed on the first long side 111. The two through holes 1310 correspond to the two magnetic columns 12 and the coils 15 winding around the magnetic columns 12. The effect of the through hole 1310 in this embodiment is the same as that in the second embodiment. Therefore, no further elaboration is necessary.

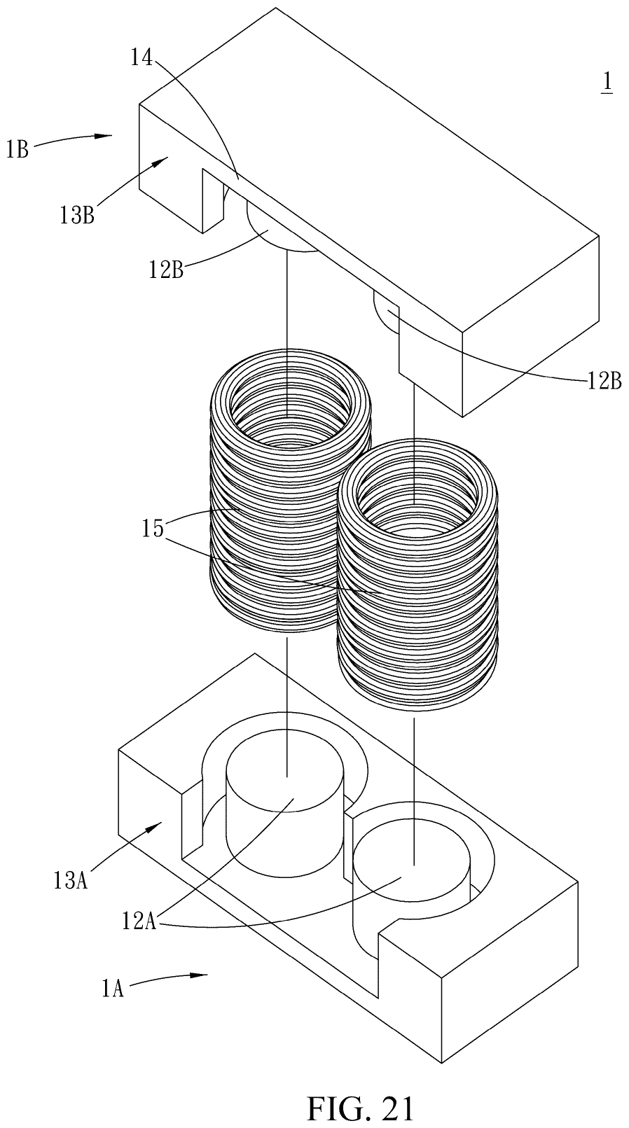

Furthermore, in this embodiment, the cross-sectional area of the magnetic columns 12 on the horizontal plane (shown in FIG. 21) has a specific ratio compared to the cross-sectional area of the sidewall 13 on the horizontal plane (shown in FIG. 21). The cross-sectional area of the magnetic columns 12 on the horizontal plane has a specific ratio compared to the area of the bottom plate 11 or the cover plate 14 (shown in FIG. 20). The illustrations are as following.

The first cross-sectional area A1 of the sidewall 13 is equal to the second cross-sectional area A2 of the sidewall 13. The first cross-sectional area A1 of the sidewall 13 (or the second cross-sectional area A2 of the sidewall 13) compared to the cross-sectional area A0 of the magnetic columns 12 has a ratio ranging from 0.2 to 4.

The third cross-sectional area A3 of the sidewall 13 compared to the cross-sectional area A0 of the magnetic columns 12 has a ratio ranging from 0.05 to 1.

The cross-sectional area A4 of the bottom plate 11 is equal to the cross-sectional area A5 of the cover plate 14. The cross-sectional area A4 of the bottom plate 11 (or the cross-sectional area A5 of the cover plate 14) compared to the cross-sectional area A0 of the magnetic columns 12 has a ratio ranging from 0.2 to 0.8. The above numerical range of the structure can be adjusted according to the user's needs.

Please refer to FIG. 21, which is an exploded view of the magnetic core structure according to the eleventh embodiment of the present application. As shown in the figure, the difference between the present embodiment and the tenth embodiment lies in the assemble manner of the structure. In the magnetic core structure 1 of this embodiment, each of the magnetic columns 12 includes a lower magnetic column 12A and an upper magnetic column 12B corresponding to the lower magnetic column 12A, and the upper magnetic column 12B is stacked on the lower magnetic column 12A to form a complete magnetic column 12. In addition, the sidewall 13 of the magnetic core structure 1 includes a lower sidewall 13A and a upper sidewall 13B corresponding to the lower sidewall 13A, and the upper sidewall 13B is stacked on the lower sidewall 13A to form a complete sidewall 13. The bottom plate 11, two lower magnetic columns 12A and the lower sidewall 13A are integrally formed to form the first magnetic core 1A. The cover plate 14, two upper magnetic columns 12B and the upper sidewall 13B are integrally formed to form the second magnetic core 1B. The first magnetic core 1A and the second magnetic core 1B have the same structure. Then, the first magnetic core 1A, the second magnetic core 1B and the coils are assembled. The effect in this embodiment is the same as that in the third embodiment. Therefore, no further elaboration is necessary.

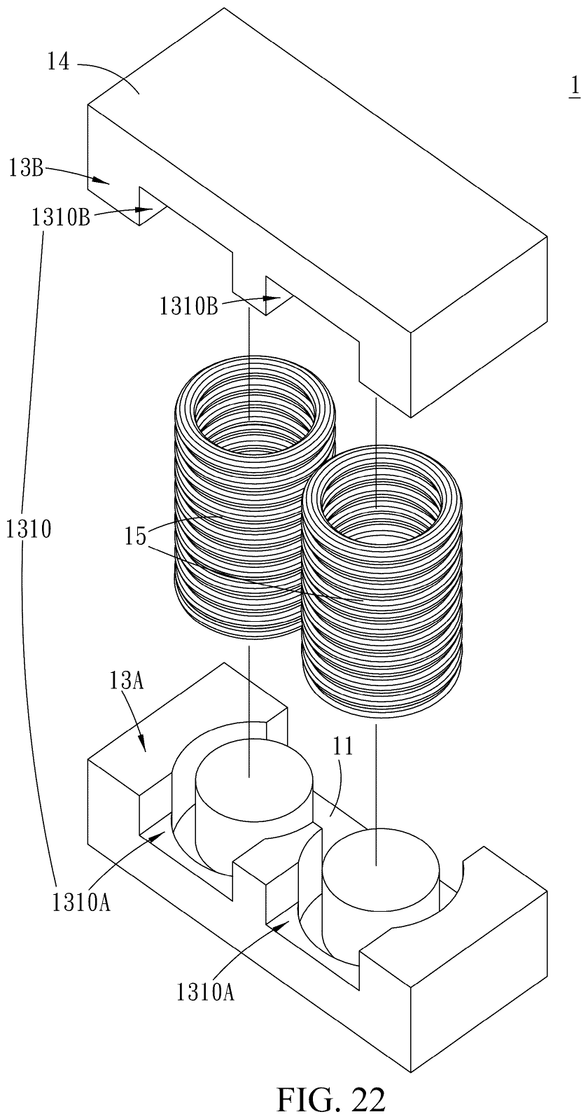

Please refer to FIG. 22, which is an exploded view of a magnetic core structure according to the twelfth embodiment of the present application. As shown in the figure, the difference between the present embodiment and the eleventh embodiment lies in the through hole 1310. In this embodiment, the first wall portion 131A of the lower sidewall 13A has a lower notch 1310A; the first wall portion 131B of the upper sidewall 13B has an upper notch 1310B, the lower notch 1310A corresponds to the upper notch 1310B with each other, and the through hole 1310 is composed of the lower notch 1310A and the upper notch 1310B. The effect of the through hole 1310 in this embodiment is the same as that in the second embodiment. Therefore, no further elaboration is necessary.

To sum up, the present application provides a magnetic core structure through the design of the sidewall structure relative to the two magnetic columns. The two coils are wound around the two magnetic columns, and current flows through the two coils to generate a magnetic field. The sidewall can improve the magnetic field of the coil and effectively reduce the overall losses caused by the core structure to the coil. Furthermore, the design of the sidewall in the magnetic core structure is beneficial for air convection to perform heat dissipation for the magnetic columns and the coils.

It is to be understood that the term “comprises”, “comprising”, or any other variants thereof, is intended to encompass a non-exclusive inclusion, such that a process, method, article, or device of a series of elements not only include those elements but also comprises other elements that are not explicitly listed, or elements that are inherent to such a process, method, article, or device. An element defined by the phrase “comprising a . . . ” does not exclude the presence of the same element in the process, method, article, or device that comprises the element.

Although the present invention has been explained in relation to its preferred embodiment, it does not intend to limit the present invention. It will be apparent to those skilled in the art having regard to this present invention that other modifications of the exemplary embodiments beyond those embodiments specifically described here may be made without departing from the spirit of the invention. Accordingly, such modifications are considered within the scope of the invention as limited solely by the appended claims.

1. A magnetic core structure, comprising:
a bottom plate;
two magnetic columns disposed on the bottom plate;
a sidewall having a first wall portion, a second wall portion and a third wall portion, wherein the first wall portion and the second wall portion are disposed on two sides of the bottom plate along an axial direction of the two magnetic columns, the third wall portion is disposed between the two magnetic columns, and the third wall portion is connected to the first wall portion and the second wall portion, respectively; and
a cover plate disposed on the sidewall and covering the two magnetic columns.

2. The magnetic core structure as claimed in claim 1, wherein the bottom plate has a first long side, a second long side, a first short side and a second short side, the first long side and the second long side are opposite to each other, the first short side and the second short side are disposed between the first long side and the second long side, the first wall potion is disposed on the first long side, and the second wall portion is disposed on the second long side.

3. The magnetic core structure as claimed in claim 2, wherein two ends of the first wall portion extend along the first long side, and two ends of the first wall portion extend and turn to the first short side and the second short side, respectively, and two ends of the second wall portion extend along the second long side, respectively.

4. The magnetic core structure as claimed in claim 3, wherein the turned extension length of the two ends of the first wall portion is located within a range of a vertical projection of the adjacent magnetic columns to the first short side and the second short side.

5. The magnetic core structure as claimed in claim 3, wherein the extension length of the two ends of the second wall portion is located within a range of vertical projections of the two magnetic columns onto the second long side.

6. The magnetic core structure as claimed in claim 3, wherein two first openings are located at corners constituted by the second long side and the first short side and constituted by the second long side and the second short side, respectively.

7. The magnetic core structure as claimed in claim 2, wherein the two ends of the first wall portion extend over a range of vertical projections of the two magnetic columns onto the first long side, and the two ends of the second wall portion extend over a range of vertical projections of the two magnetic columns onto the second long side, respectively.

8. The magnetic core structure as claimed in claim 7, wherein an extension length of the two ends of the first wall portion is the same as that of the two ends of the second wall portion.

9. The magnetic core structure as claimed in claim 7, wherein two second openings are disposed between the two ends of the first wall portion and the two ends of the second wall portion, and the two second openings are located at the first short side and the second short side, respectively.

10. The magnetic core structure as claimed in claim 1, wherein the first wall portion has two through holes corresponding to the two magnetic columns.

11. The magnetic core structure as claimed in claim 1, wherein the sidewall adjacent to cylindrical surfaces of the two magnetic columns has a corresponding curved wall surface, and a gap is located between the curved wall surface of the sidewall and cylindrical surfaces of the two magnetic columns.

12. The magnetic core structure as claimed in claim 11, further comprising two coils winding with the two magnetic columns, and the two coils are disposed within the gap.

13. A magnetic core structure, comprising:
a bottom plate;
two magnetic columns disposed on the bottom plate;
a sidewall having a first wall portion and a second wall portion, wherein the first wall portion is disposed on a side of the bottom plate along an axial direction of the two magnetic columns, the first wall portion extends and turns to adjacent sides of the bottom plate, and one end of the second wall portion extends from the first wall portion by passing a space between the two magnetic columns; and
a cover plate disposed on the sidewall and covering the two magnetic columns.

14. The magnetic core structure as claimed in claim 13, wherein the bottom plate has a first long side, a second long side, a first short side and a second short side, the first long side and the second long side are opposite to each other, the first short side and the second short side are disposed between the first long side and the second long side, and the first wall portion is disposed on the first long side, the first short side and the second short side.

15. The magnetic core structure as claimed in claim 14, wherein a third opening is disposed between two ends of the first wall portion and the third opening is disposed on the second long side.

16. The magnetic core structure as claimed in claim 14, wherein the first wall portion on the first long side has two through holes corresponding to the two magnetic columns, respectively.

17. The magnetic core structure as claimed in claim 13, wherein the first wall portion and the second wall portion adjacent to cylindrical surfaces of the two magnetic columns have corresponding curved wall surfaces, and a gap is located among the curved wall surfaces of the first wall portion and the second wall portion and the cylindrical surfaces of the two magnetic columns.

18. The magnetic core structure as claimed in claim 17, further comprising two coils winding with the two magnetic columns, and the two coils are disposed within the gap.
